(19) United States
(12) Patent Application Publication
(10) Pub. No.: US 2024/0374465 A1
(43) Pub. Date: Nov. 14, 2024

(54) ROLLER ASSEMBLY FOR MASSAGE

(71) Applicant: Hyundai Transys Inc., Seosan-si (KR)

(72) Inventors: Gu Chang KANG, Hwaseong-si (KR); Hyun Seok SONG, Hwaseong-si (KR); Tae Hyoung YANG, Hwaseong-si (KR); Ui Jeong LEE, Hwaseong-si (KR)

(21) Appl. No.: 18/649,153

(22) Filed: Apr. 29, 2024

(30) Foreign Application Priority Data
May 10, 2023 (KR) 10-2023-0060331

(51) Int. Cl. A61H 15/00

(52) U.S. Cl. CPC A61H 15/0078; A61H 2015/0014; A61H 2015/0021; A61H 2201/0149; A61H 2201/1238

(57) ABSTRACT

Provided is a roller assembly for massage, the roller assembly including a roller having one side surface coupled to a first frame, and another side surface coupled to a second frame, a central shaft penetrating a center of the roller, and an air injection member coupled to one side of the central shaft so as to be tightly attached to the first frame and having an air injection part disposed at an outer side thereof so that air is injected into the roller through the air injection part.

### CROSS-REFERENCE TO RELATED APPLICATIONS

This application claims priority to and the benefit of Korean Patent Application No. 10-2023-0060331 filed in the Korean Intellectual Property Office on May 10, 2023, the entire contents of which are incorporated herein by reference.

### TECHNICAL FIELD

The present invention relates to a roller assembly for massage mounted in a mounting object such as a vehicle seat.

### BACKGROUND ART

In general, massage devices such as massage chairs and massage beds may assist in recovering users from fatigue by activating metabolism by promoting flows of bodily fluids, such as blood, lymphatic fluids, and tissue fluids by appropriately stimulating skin and muscles by moving massage balls in a state in which the massage balls are in contact with skin.

The massage balls, which are applied to the massage device, such as a massage chair or a massage bed, may be made of a material, such as nitrile butadiene rubber (NBR) or hydrogenated nitrile rubber (HNBR) with high density and hardness, and manufactured in the form of rollers.

However, the massage ball in the related art cannot be changed in shape and hardness once the massage ball is completely manufactured, which makes it impossible to adjust hardness of the massage ball in accordance with massage strength of the massage ball felt by a person who receives massage.

### DOCUMENT OF RELATED ART

### Patent Document

(Patent Document 1) Korean Patent No. 10-2267028 (published on Jun. 18, 2021)

### SUMMARY OF THE INVENTION

The present invention has been made in an effort to solve the above-mentioned problem, and an object of the present invention is to provide a roller assembly for massage capable of adjusting hardness of a roller in accordance with massage contact strength felt by a user by supplying air to the roller.

In order to achieve the above-mentioned object, the present invention provides a roller assembly for massage, the roller assembly including a roller having one side surface coupled to a first frame, and the other side surface coupled to a second frame, a central shaft configured to penetrate a center of the roller, and an air injection member coupled to one side of the central shaft so as to be tightly attached to the first frame and having an air injection part provided at an outer side thereof so that air is injected into the roller through the air injection part.

In addition, the air injection member may have therein an air injection chamber configured to communicate with the inside of the roller.

In addition, the roller and the first frame may be connected by a fixing bead.

In addition, the first frame may have an air hole, and the air hole may communicate with the air injection chamber and the inside of the roller.

In addition, the air injection part may be a nipple.

In addition, the air injection member may be fixedly coupled to the central shaft and rotatable together with the central shaft, and the roller may be rotatable about the central shaft together with the first frame and the second frame.

In addition, the first frame may have an outer wheel portion, and the outer wheel portion may be assembled to surround an outer-diameter portion of the air injection member.

In addition, the roller may be made of a rubber-based material.

According to the present invention, the roller may expand or contract as air is injected into the roller or air is discharged from the roller. Therefore, the hardness of the roller may be adjusted in accordance with massage strength felt by the user.

In addition, according to the present invention, the air injection member may rotate together with the central shaft, and the roller may rotate about the central shaft together with the first and second frames, which may prevent the air hose connected to the air injection part from being twisted.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a roller assembly for massage according to an exemplary embodiment of the present invention.

FIG. 2 is a side view of the roller assembly for massage according to the exemplary embodiment of the present invention.

FIG. 3 is a cross-sectional view taken along line A-A in FIG. 2.

FIG. 4 is a view illustrating a state in which the roller assembly for massage according to the exemplary embodiment of the present invention is coupled to a frame of a massage device.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present invention, the specific descriptions of publicly known related configurations or functions will be omitted when it is determined that the specific descriptions may obscure the subject matter of the present invention. Further, the exemplary embodiments of the present invention will be described below, but the technical spirit of the present invention is not limited thereto and may of course be modified and variously carried out by those skilled in the art.

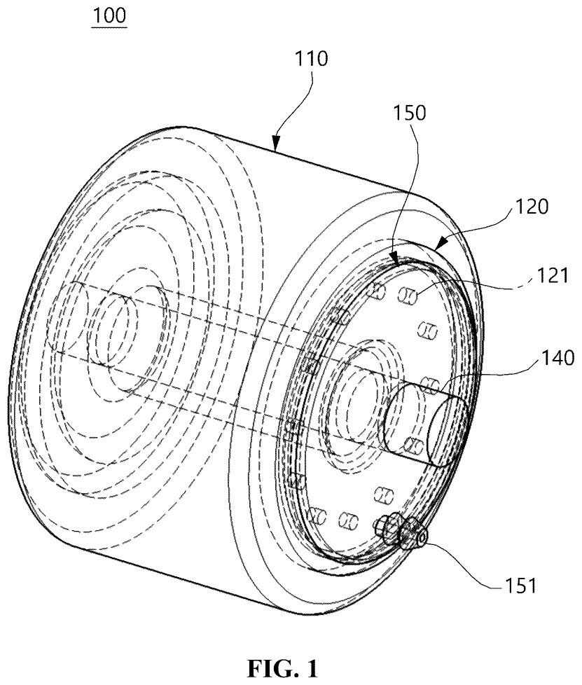

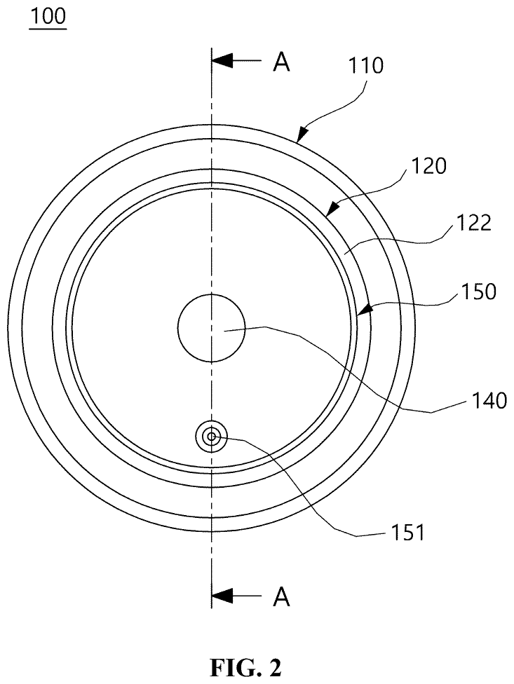

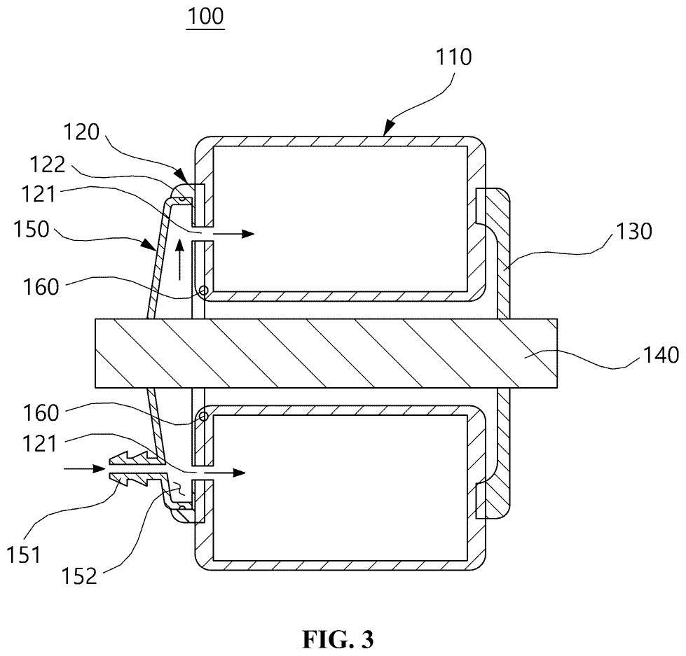

FIG. 1 is a perspective view of a roller assembly for massage according to an exemplary embodiment of the present invention, FIG. 2 is a side view of the roller assembly for massage according to the exemplary embodiment of the present invention, and FIG. 3 is a cross-sectional view taken along line A-A in FIG. 2.

As illustrated in FIGS. 1 to 3, a roller assembly 100 for massage according to the present invention includes a roller 110 into which air is injected, a central shaft 140 assembled to penetrate a center of the roller 110, and an air injection member 150 coupled to one side of the central shaft 140.

A first frame 120 may be coupled to one side surface of the roller 110. A second frame 130 may be coupled to the other side surface of the roller 110.

For example, the roller 110 may be made of a rubber-based material such as nitrile butadiene rubber (NBR) and expand when air is injected into the roller 110.

The roller 110 may rotate about the central shaft 140. The first frame 120 and the second frame 130 may rotate together with the roller 110 when the roller 110 rotates.

The roller 110 and the first frame 120 may be connected by fixing beads 160.

The first frame 120 may have air holes 121. The air holes 121 may communicate with an air injection chamber 152 of the air injection member 150 and the inside of the roller 110.

The air injection member 150 may be fixedly coupled to one side of the central shaft 140 so as to be tightly attached to the first frame 120. When the central shaft 140 rotates, the air injection member 150 may rotate together with the central shaft 140.

The air injection member 150 may have an air injection part 151. Air may be injected into the roller 110 through the air injection part 151. For example, the air injection part 151 may be a nipple.

For example, the air injection part 151 may be connected to an air hose (not illustrated) of an air supply device such as a compressor.

The air injection chamber 152 may be provided in the air injection member 150. The air supplied through the air injection part 151 may be injected into the air injection chamber 152. The air in the air injection chamber 152 may be inserted into the roller 110 via the air hole 121 of the first frame 120. The roller 110 may expand when the air is injected.

The hardness of the roller 110 may vary depending on a degree to which the air is injected. For example, as the amount of air injected into the roller 110 increases, the hardness of the roller 110 may increase.

The first frame 120 may have an outer wheel portion 122. The outer wheel portion 122 may be assembled to surround an outer-diameter portion of the air injection member 150.

For example, a sealing member (not illustrated), such as an O-ring, may be coupled between the outer wheel portion 122 and the outer-diameter portion of the air injection member 150 to seal a portion between the outer wheel portion 122 and the outer-diameter portion of the air injection member 150.

The roller 110 may contract when the air in the roller 110 is discharged. When the air is discharged, the hardness of the roller 110 may decrease.

For example, a discharge valve (not illustrated) may be provided on the second frame 130. The air in the roller 110 may be discharged through the discharge valve.

Next, an operation of the present invention will be described.

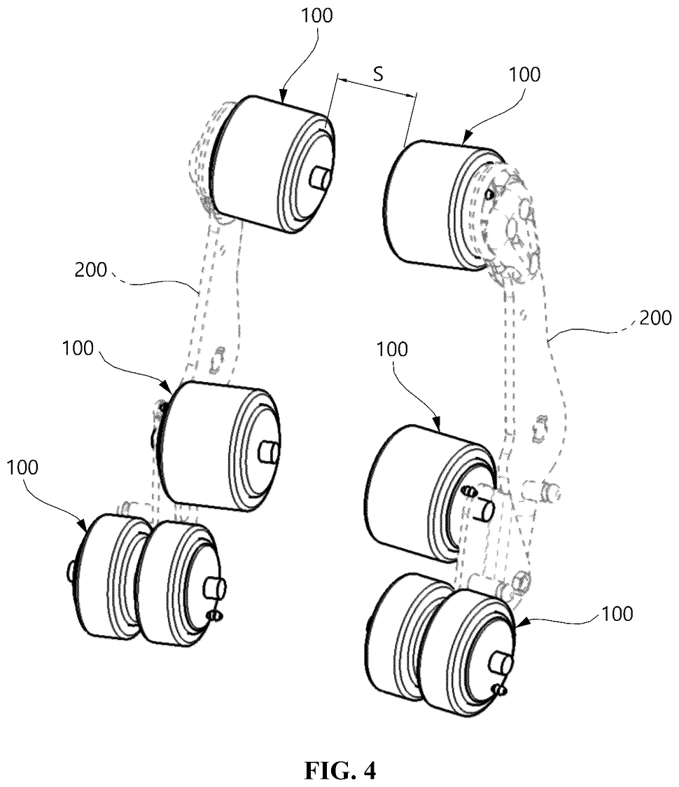

FIG. 4 is a view illustrating a state in which the roller assembly for massage according to the exemplary embodiment of the present invention is coupled to a frame of a massage device.

As illustrated in FIG. 4, the roller assemblies 100 for massage may be coupled to frames 200 of the massage devices provided at two left and right sides.

Air is injected into the two left and right roller assemblies 100 for massage coupled to the frames 200 of the two left and right massage devices. The air may be injected into the roller 110 through the air injection part 151 (see FIG. 3).

The air injected into the air injection part 151 may flow into the air injection chamber 152. The air injected into the air injection chamber 152 may flow into the roller 110 through the air hole 121.

When the air flows into the roller 110, the roller 110 may expand in the direction of the second frame 120. The hardness of the roller 110 may increase as the roller 110 expands.

As the rollers 110 expand, an interval S between the two roller assemblies 100 for massage coupled to the frames 200 of the two left and right massage devices may decrease.

On the contrary, when the air in the rollers 110 is discharged, the interval S between the two roller assemblies 100 for massage may increase.

As described above, according to the present invention, the roller may expand or contract as air is injected into the roller or air is discharged from the roller. Therefore, the hardness of the roller may be adjusted in accordance with massage strength felt by the user. In addition, according to the present invention, the air injection member may rotate together with the central shaft, and the roller may rotate about the central shaft together with the first and second frames, which may prevent the air hose connected to the air injection part from being twisted.

The above description is simply given for illustratively describing the technical spirit of the present invention, and those skilled in the art to which the present invention pertains will appreciate that various modifications, changes, and substitutions are possible without departing from the essential characteristic of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A roller assembly for massage, the roller assembly comprising:
a roller having one side surface coupled to a first frame, and another side surface coupled to a second frame;
a central shaft penetrating a center of the roller; and
an air injection member coupled to one side of the central shaft to be tightly attached to the first frame and having an air injection part disposed at an outer side of the air injection member, the air injection part being configured to receive air therethrough to inject the air into the roller.

2. The roller assembly of claim 1, wherein the air injection member has therein an air injection chamber configured to communicate with an inside of the roller.

3. The roller assembly of claim 1, wherein the roller and the first frame are connected by a fixing bead.

4. The roller assembly of claim 2, wherein the first frame has an air hole, and the air hole is configured to communicate with the air injection chamber and the inside of the roller.

5. The roller assembly of claim 1, wherein the air injection part has a nipple.

6. The roller assembly of claim 1, wherein the air injection member is fixedly coupled to the central shaft and rotatable together with the central shaft, and
wherein the roller is rotatable about the central shaft together with the first frame and the second frame.

7. The roller assembly of claim 1, wherein the first frame has an outer wheel portion. and the outer wheel portion surrounds an outer-diameter portion of the air injection member.

8. The roller assembly of claim 1, wherein the roller has a rubber-based material.
